(19) United States
(12) Patent Application Publication
(10) Pub. No.: US 2021/0321262 A1
(43) Pub. Date: Oct. 14, 2021

(54) SHARED SYSTEM AND CONNECTION MODE SWITCHING METHOD

(71) Applicant: KABUSHIKI KAISHA TOKAI RIKA DENKI SEISAKUSHO, Aichi (JP)

(72) Inventors: Yuichi INAMI, Aichi (JP); Masahiko OYA, Aichi (JP); Masahiro ARAKAWA, Aichi (JP); Tomohiro TSUCHIYA, Aichi (JP)

(21) Appl. No.: 17/054,005

(22) PCT Filed: May 10, 2019
(86) PCT No.: PCT/JP2019/018678

§ 371 Date: Nov. 9, 2020

(30) Foreign Application Priority Data
May 15, 2018 (JP) 2018-093985

(51) Int. Cl. H04W 12/48; H04W 12/50; H04L 29/06; H04W 4/80

(52) U.S. Cl. CPC H04W 12/48; H04W 4/80; H04L 63/20; H04W 12/50

(57) ABSTRACT

A sharing system includes an authentication device arranged in an operation subject. The sharing system includes mobile terminals that obtain code information required to use the operation subject. The mobile terminals are allowed by the authentication device to operate the operation subject if authenticated through communication with the authentication device. The sharing system further includes a terminal checking unit that checks how many of the mobile terminals located near the authentication device can connect to the authentication device in a manner allowing for communication and can operate the operation subject. The sharing system further includes a connection switching unit that switches a connection mode of the mobile terminals that are connected to the authentication device in a manner allowing for communication based on a checking result of the terminal checking unit.

### TECHNICAL FIELD

The present invention relates to a sharing system that allows an operation subject to be used by mobile terminals of users and a method for switching a connection mode.

### BACKGROUND ART

In the prior art, an example of a conventional sharing system in which the same operation subject is used by a number of persons is a car sharing system that allows the same vehicle to be used by a number of persons (refer to Patent Documents 1 and 2). In this type of car-sharing system, for example, the use of car sharing is registered in advance. After making a reservation for use of a vehicle with, for example, a mobile terminal (high-performance mobile phone, etc.), the use of the vehicle is permitted during a reserved period of time.

### PRIOR ART DOCUMENTS

### Patent Documents

Patent Document 1: Japanese Laid-Open Patent Publication No. 2016-115077

Patent Document 2: Japanese Laid-Open Patent Publication No. 2016-71834

### SUMMARY OF THE INVENTION

### Problems that the Invention is to Solve

This type of car sharing system is inconvenient when only the mobile terminal of the person who made the reservation is granted privilege to use the vehicle since other persons will not be able to use the vehicle. Thus, studies have been conducted to give vehicle operation privilege to multiple mobile terminals. In this case, the connection mode for communication of the mobile terminals is switched from automatic connection to manual connection in order to maintain a one-to-one relationship between a mobile terminal and the vehicle. However, this may be inconvenient because when the mobile terminals are all unconditionally switched to manual connection, even if there is only one mobile terminal located near the vehicle, the mobile terminal must be manually operated to be connected to the vehicle in a manner allowing for communication. This problem is not limited to a car sharing system in which a vehicle serves as an operation subject and also arises in a sharing system that allows an operation subject to be operated by multiple mobile terminals.

It is an objective of the present invention to provide a sharing system and a method for switching a connection mode that can set the optimal connection mode for a mobile terminal.

### Means for Solving the Problem

In one aspect, a sharing system includes an authentication device arranged in an operation subject and mobile terminals that obtain code information required to use the operation subject, in which the mobile terminals are allowed by the authentication device to operate the operation subject if authenticated through communication with the authentication device. The sharing system includes a terminal checking unit that checks how many of the mobile terminals located near the authentication device can connect to the authentication device in a manner allowing for communication and can operate the operation subject and a connection switching unit that switches a connection mode of the mobile terminals that are connected to the authentication device in a manner allowing for communication based on a checking result of the terminal checking unit.

With this structure, even if multiple mobile terminals have been granted privilege to operate the operation subject in advance, the connection mode of the mobile terminals is set based on the number of mobile terminals that are actually located near the operation subject at the moment. Thus, the connection mode of the mobile terminals will be appropriately set in accordance with the number of mobile terminals that are actually located near the operation subject at the moment rather than the number of mobile terminals granted privilege to operate the operation subject. This optimally sets the connection mode of the mobile terminals.

In the sharing system, preferably, the connection switching unit switches the connection mode to automatic connection or manual connection in accordance with how many of the mobile terminals are connectable to the authentication device. With this structure, when there are multiple mobile terminals, the connection mode will be set to manual connection, and when there is only one mobile terminal, the connection mode will be set to automatic connection. Accordingly, even if multiple mobile terminals have been granted privilege to operate the operation subject, when there is only one mobile terminal located near the operation subject, the connection mode of the mobile terminal will be set to automatic connection. This improves usability when connecting the mobile terminal to the authentication device in a manner allowing for communication.

In the sharing system, when the mobile terminals are granted privilege to operate the operation subject, preferably, the mobile terminals each return a response to a call transmitted from the authentication device, and the terminal checking unit checks how many of the mobile terminals are located near the authentication device by monitoring the response. With this structure, if a call is transmitted from the authentication device, only the mobile terminals that are granted privilege to operate the operation subject can return a response and the other terminals that are not granted privilege or are irrelevant cannot return a response.

In the sharing system, preferably, the terminal checking unit checks whether two or more of the mobile terminals are located near the authentication device by monitoring over a fixed time whether responses from two or more of the mobile terminals are received in response to a call transmitted from the authentication device. With this structure, the simple process of monitoring a response from the mobile terminals over a fixed time allows for recognition of the number of the mobile terminals that are located nearby.

In another aspect, a method for switching a connection mode of a sharing system is provided. The sharing system includes an authentication device arranged in an operation subject and mobile terminals that obtain code information required to use the operation subject. The mobile terminals are allowed by the authentication device to operate the operation subject if authenticated through communication with the authentication device. The method includes checking how many of the mobile terminals located near the authentication device can connect to the authentication device in a manner allowing for communication and can operate the operation subject and switching a connection mode of the mobile terminals that are connected to the authentication device in a manner allowing for communication based on a checking result of how many of the mobile terminals are connected.

### Effects of the Invention

The present invention optimally sets the connection mode of mobile terminals.

### BRIEF DESCRIPTION OF THE DRAWINGS

FIG. 1 is a diagram showing a sharing system according to one embodiment.

FIG. 2 is a diagram illustrating a procedure for authenticating code information.

FIG. 3 is a diagram illustrating a procedure for operating an onboard device with a mobile terminal.

FIG. 4 is a diagram illustrating a procedure for granting operation privilege.

FIG. 5 is a flowchart showing a communication procedure when there is one connectable mobile terminal.

FIG. 6 is a flowchart showing a communication procedure when there are multiple connectable mobile terminals.

### EMBODIMENTS OF THE INVENTION

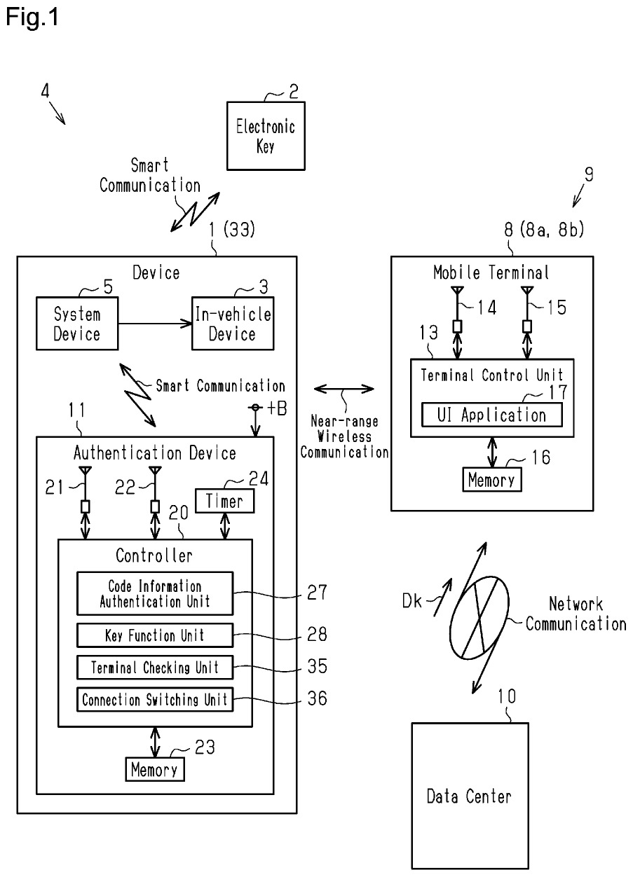

A sharing system and a method for switching a connection mode according to one embodiment will now be described with reference to FIGS. 1 to 6.

As shown in FIG. 1, a vehicle 1 includes an electronic key system 4 in which ID verification is performed through wireless communication established with an electronic key 2 to execute or permit actuation of an in-vehicle device 3. The electronic key system 4 is a key-operation-free system in which ID verification (smart verification) is performed through near-range wireless communication when communication is established with the vehicle 1. The in-vehicle device 3 includes, for example, a door lock device and an engine.

The electronic key system 4 includes a system device 5 that actuates the electronic key system 4 in the vehicle 1. The electronic key 2 and the system device 5 store an electronic key ID and a unique electronic key encryption code that are used for smart verification. The electronic key 2 and the system device 5 perform the smart verification through bidirectional communication in which radio waves are transferred to each other. The smart verification includes, for example, electronic key ID verification that checks the authenticity of an electronic key ID or challenge-response authentication that uses the unique electronic key encryption code. Radio waves are transmitted from the system device 5 to the electronic key 2 in the low frequency (LF) band and from the electronic key 2 to the system device 5 in the ultra-high frequency (UHF) band.

The system device 5 performs smart communication with the electronic key 2 that is located outside the passenger compartment (exterior smart communication). If smart verification (exterior smart verification) is accomplished, the system device 5 permits or performs locking or unlocking of a vehicle door. Thus, touching of an exterior door handle unlocks the vehicle door, and operation of a lock button on the exterior door handle locks the vehicle door. The system device 5 also performs smart communication with the electronic key 2 that is located inside the passenger compartment (interior smart communication). If smart verification (interior smart verification) is accomplished, the system device 5 permits a shifting operation of a vehicle power supply. Then, an engine switch near the driver seat is pushed while a brake pedal is depressed to start the engine.

When the vehicle 1 is a shared vehicle shared by, for example, multiple persons, the vehicle 1 includes a sharing system 9, or a car sharing system that allows the vehicle 1 to be operated with a mobile terminal 8 carried by each user for a specified time that has been reserved. The sharing system 9 of the present example registers encrypted code information Dk from an external device (in present example, data center 10) to the mobile terminal 8. Further, the sharing system 9 authenticates the code information Dk with the mobile terminal 8 and an authentication device 11 arranged in the vehicle 1. The sharing system 9 uses the authentication result as one condition for allowing operation of the vehicle 1. The code information Dk is, for example, a type of key including a data element such as a usage time limit. Preferably, the code information Dk is a one-time key (one-time password) that can be used only once.

The mobile terminal 8 includes a terminal control unit 13, a network communication module 14, a near-range wireless communication module 15, and a memory 16. The terminal control unit 13 controls the actuation of the mobile terminal 8. The network communication module 14 performs network communication. The near-range wireless communication module 15 performs near-range wireless communication. Data is rewritable to the memory 16. When the mobile terminal 8 obtains the code information Dk through network communication from the data center 10, the mobile terminal 8 stores the code information Dk in the memory 16. Preferably, the near-range wireless communication is, for example, Bluetooth (registered trademark) communication.

The mobile terminal 8 includes a user interface application 17 that manages the actuation of the sharing system 9. The user interface application 17 is downloaded from, for example, the data center 10 and installed in the terminal control unit 13. The terminal control unit 13 executes the user interface application 17 to perform various types of processes such as a procedure for using the vehicle 1 (user authentication, reservation procedure), a locking or unlocking operation of a vehicle door, and a starting operation of the engine of the vehicle 1.

The authentication device 11 includes a controller 20 that controls actuation of the authentication device 11, a smart communication block 21 that performs smart communication, a near-range wireless communication module 22 that performs near-range wireless communication, a memory 23 that stores rewritable data, and a timer 24 that manages date and time. An authentication device ID registered in the authentication device 11 is linked to, for example, a vehicle body ID (vehicle body number) of the vehicle 1 so that the authentication device 11 has a one-to-one relationship with the vehicle 1. The timer 24 is, for example, a software timer.

The authentication device 11 includes a code information authentication unit 27 that authenticates the code information Dk registered to the mobile terminal 8 and a key function unit 28 that actuates the authentication device 11 in the same manner as the electronic key 2. The code information authentication unit 27 and the key function unit 28 are arranged in the controller 20. The code information authentication unit 27 obtains the code information Dk from the mobile terminal 8 through near-range wireless communication and authenticates the code information Dk. If the authentication of the code information Dk is accomplished, the code information authentication unit 27 shifts the key function unit 28 to an ON state (enabled). The key function unit 28, when shifted to the ON state, can perform smart communication (smart verification) with the electronic key system 4.

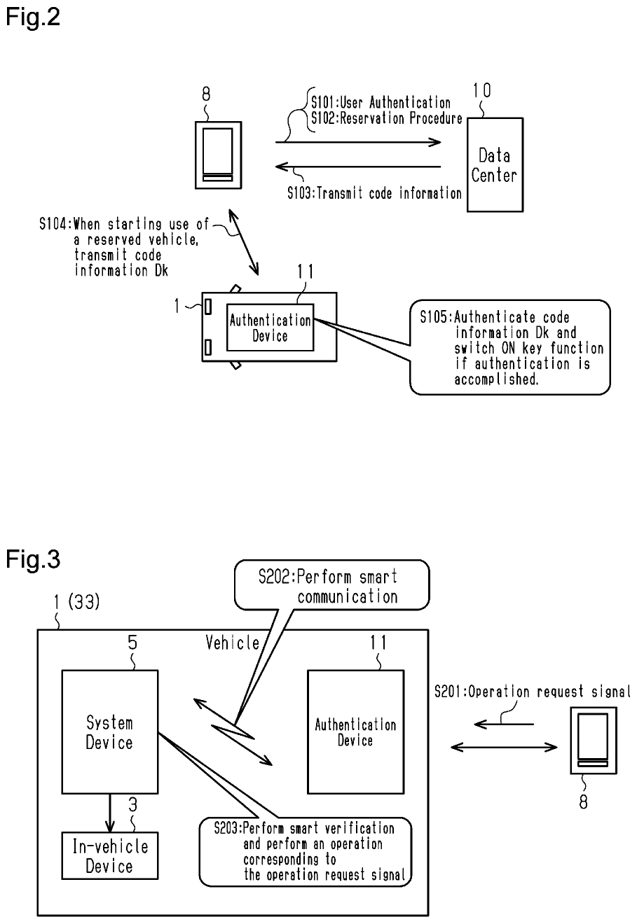

FIG. 2 shows the procedure for authenticating code information Dk. In step 101 of

FIG. 2, the mobile terminal 8 performs user authentication with the data center 10 through network communication. The user authentication checks a user ID and a password that are assigned to the user when registering for use of the sharing system 9.

In step 102, the mobile terminal 8 performs a procedure for reserving the vehicle 1 with the data center 10 through network communication. In the reservation procedure, the used vehicle, the date and time of use, and the like are input and transmitted to the data center 10.

In step 103, if the user authentication is accomplished, the data center 10 generates and transmits code information Dk to the mobile terminal 8 through network communication. In this case, the data center 10 generates the code information Dk from information obtained in the reservation procedure. The code information Dk in the present example is ciphertext generated by encrypting plaintext including data elements such as “reserved date and time,” a “terminal ID,” a “user authentication code,” and a “group ID” with a cipher (encryption algorithm) using an encryption code (e.g. unique authentication device encryption code) of the authentication device 11 of a reserved vehicle. The terminal ID is a unique ID of the mobile terminal 8. The user authentication code is one type of code used in encrypted communication performed between the mobile terminal 8 and the authentication device 11 when operating the vehicle 1 with, for example, the mobile terminal 8. The group ID is a unique ID for identifying a group. The mobile terminal 8 receives code information Dk from the data center 10 and stores the code information Dk in the memory 16.

In step 104, when starting use of the reserved vehicle, the mobile terminal 8 transmits the code information Dk, which is registered in the mobile terminal 8, through near-range wireless communication. The code information Dk is transmitted to the authentication device 11 using, for example, Bluetooth Low Energy (BLE).

In step 105, the authentication device 11 receives the code information Dk from the mobile terminal 8 and authenticates the code information Dk. In the present example, the code information authentication unit 27 decrypts the code information Dk with the encryption code (e.g. unique authentication device encryption code) and checks whether the decryption is successful. When the decryption of the code information Dk is successful, the “reserved date and time, the “terminal ID,” the “user authentication code,”, and the “group ID” included in the code information Dk can be obtained. The vehicle 1 can be operated with the mobile terminal 8 for the specified time that has been reserved.

If the authentication of the code information Dk is successful, the authentication device 11 shifts to an “authentication completion state” with regard to the code information Dk and switches ON the key function unit 28 (smart function is activated). Thus, the key function unit 28 is allowed to perform smart communication (smart function) through the electronic key system 4. Further, when the authentication of the code information Dk is accomplished, the authentication device 11 stores the code information Dk and the user authentication code in the memory 23.

When the code information Dk is authenticated, the authentication device 11 performs near-range wireless communication to notify the mobile terminal 8 of the user authentication code obtained through the authentication. The mobile terminal 8 receives the user authentication code from the authentication device 11 and registers the user authentication code to the memory 16. In this manner, the user authentication code is registered to both of the mobile terminal 8 and the authentication device 11. When the mobile terminal 8 actuates the vehicle 1 through the authentication device 11, the user authentication code is used in encrypted communication between the mobile terminal 8 and the authentication device 11.

FIG. 3 illustrates a procedure for operating the vehicle 1 with the mobile terminal 8. In step 201 of FIG. 3, when an operation request button (display button on screen) of the mobile terminal 8 is operated in the authentication completion state, the mobile terminal 8 transmits an operation request signal, which corresponds to the button, to the authentication device 11 through near-range wireless communication. The operation request button may be an unlock request button operated to unlock, for example, a vehicle door, a lock request button operated to lock the vehicle door, or an engine start request button operated so that the vehicle 1 permits starting of the engine. The operation request signal includes a command corresponding to the operation request button that has been operated. The operation request signal is encrypted by, for example, the user authentication code when transmitted.

In step 202, when the operation request signal is received from the mobile terminal 8 when the key function unit 28 is in an ON state, the key function unit 28 performs the smart communication of the electronic key system 4 and notifies the system device 5 of the operation request signal received during the smart communication. In the present example, the key function unit 28 performs smart verification using the electronic key ID and the encryption code registered to the key function unit 28 and notifies the system device 5 of the operation request signal received from the mobile terminal 8 during the verification.

In step 203, when the system device 5 determines that smart verification performed with the authentication device 11 (key function unit 28) has been accomplished, the verification system device 5 performs an operation corresponding to the operation request signal notified by the authentication device 11. This locks or unlocks the vehicle door or permits an engine start operation.

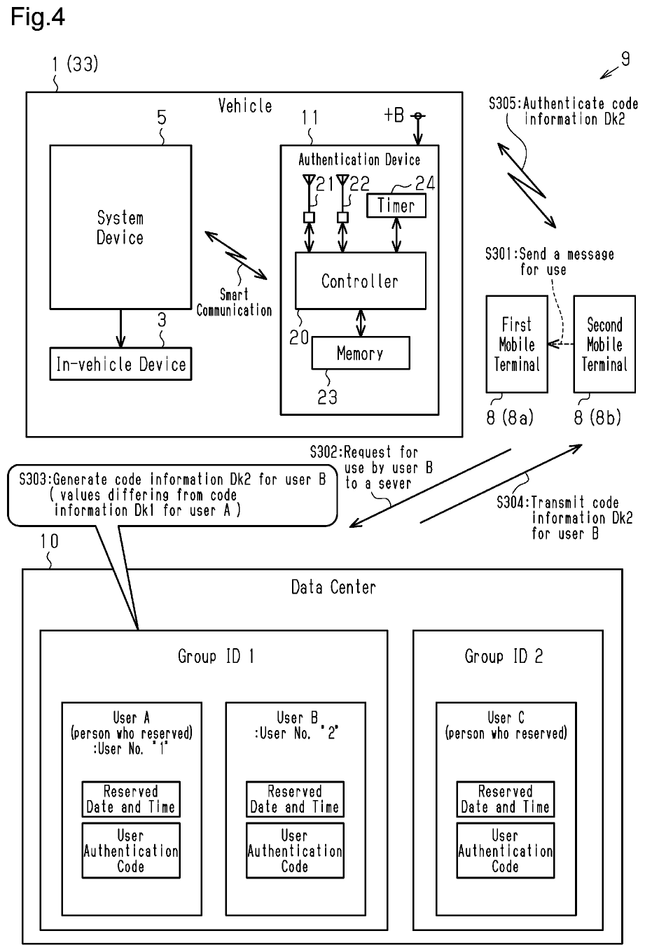

As shown in FIG. 4, the sharing system 9 includes a function that grants privilege to operate the vehicle 1 (operation authorization function) from the mobile terminal 8 (first mobile terminal 8a) that reserved the vehicle to another mobile terminal 8 (second mobile terminal 8b). The first mobile terminal 8a is a terminal used by the person who reserved the vehicle 1. The second mobile terminal 8b is a terminal used by a user that differs from the person who made the reservation (e.g., family member or the like). In the present example, the user of the first mobile terminal 8a, that is, the person reserving the vehicle 1 is referred to as “user A,” and the user of the second mobile terminal 8b, that is, a person that belongs to the same group as user A and is borrowing the vehicle 1 from user A is referred to as “user B.” A group to which user A belongs is “group ID1” and a user number for user A in the group is “1.”

In step 301, when user B uses the vehicle 1, user B sends a message for use of the vehicle 1 to user A. Preferably, the usage message is sent through, for example, a task in which user B operates his or her second mobile terminal 8b to send information indicating the desire to use the vehicle 1 to the first mobile terminal 8a carried by user A through network communication or near-range wireless communication.

In step 302, user A requests for the use of the vehicle by user B to the data center 10 by issuing operation privilege that permits user B to use the vehicle. In the present example, user A operates, for example, his or her first mobile terminal 8a to send the usage message received from user B to the data center 10. The data center 10 recognizes that user B and user A are in the same group and assigns “group ID1” to user B. In the request for use, the reserved date, time, and the like desired by user B are sent to the data center 10.

In step 303, the data center 10 sets user B to the same group (group ID1) as user A, assigns user number “2” in the group to user B, and then generates code information issued for user B (hereafter referred to as second code information Dk2). The second code information Dk2 generated by the data center 10 has values differing from the code information issued for user A (hereafter referred to as first code information Dk1). The second code information Dk2 is preferably ciphertext generated by encrypting plaintext including data elements such as a “group ID (in present example, group ID1),” a “reserved date and time,” a “terminal ID,” and a “user authentication code (differing from user authentication code included in first code information Dk1 issued for user A)” with a cipher (encryption algorithm) using a predetermined encryption code (e.g. unique authentication device encryption code or the like).

In step 304, the data center 10 sends the second code information Dk2 generated for user B to the second mobile terminal 8b of user B.

In step 305, the second mobile terminal 8b that has received the second code information Dk2 authenticates the second code information Dk2 when connected through near-range wireless communication to the authentication device 11 of the vehicle 1. The authentication of the second code information Dk2 is performed through the same process as steps 103 and 104 and will not be described. If the authentication of the second code information Dk2 is accomplished, the key function unit 28 is shifted to an ON state and the second mobile terminal 8b is granted privilege to operate the vehicle 1. In this manner, the grant of operation privilege is synonymous with an assignment (registration) of code information Dk. The second mobile terminal 8b is allowed to use the vehicle 1 in this manner.

User C in a group differing from that of users A and B may reserve the vehicle 1 from his or her mobile terminal 8. The data center 10 will recognize that user C is in a group differing from that of users A and B and thus assigns “group ID2” to user C as a group ID. The data center 10 generates different code information Dk for user C and issues the code information Dk to the mobile terminal 8 of user C. The mobile terminal 8 of user C authenticates the code information Dk, which is received from the data center 10, with the authentication device 11. If the authentication of the code information Dk is accomplished, the mobile terminal 8 is allowed to perform various types of operations on the vehicle 1. When user C is allowed to use the vehicle 1, users A and B with the group ID that differs from that of user C are not allowed to use the vehicle 1.

In FIG. 1, the sharing system 9 includes a function (connection switching function) that switches a connection mode for communication between the mobile terminal 8 and the authentication device 11 in accordance with the number of mobile terminals 8 located near the vehicle 1 (authentication device 11) as long as multiple mobile terminals 8 are granted privilege to operate an operation subject 33 (vehicle 1 in present example). In the case where multiple mobile terminals 8 are granted privilege to operate the vehicle 1, if all the mobile terminals 8 are switched to manual connection to maintain a one-to-one relationship between the mobile terminals 8 and the authentication device 11, even if there is only one mobile terminal 8 located near the vehicle 1, that mobile terminal 8 must be manually operated at the cost of convenience to be connected to the vehicle in a manner allowing for communication. The present example copes with this problem.

In the present example, the sharing system 9 includes a terminal checking unit 35 that checks how many mobile terminals 8 that can operate the vehicle 1 are located near the vehicle 1 (authentication device 11). The terminal checking unit 35 is arranged in the controller 20 of the authentication device 11. The terminal checking unit 35 recognizes that multiple mobile terminals 8 are granted privilege to operate the vehicle 1 when multiple pieces of code information Dk are registered in the authentication device 11. When multiple mobile terminals 8 are granted privilege to operate, the terminal checking unit 35 checks how many mobile terminals 8 that can communicate with the authentication device 11 and can operate the operation subject 33 (vehicle 1 in present example) are located near the authentication device 11. Further, the terminal checking unit 35 checks whether there are multiple mobile terminals 8 located nearby by monitoring a response to a call from the authentication device 11 for a fixed time.

The sharing system 9 includes a connection switching unit 36 that switches the connection mode between the mobile terminal 8 and the authentication device 11. The connection switching unit 36 is arranged in the controller 20 of the authentication device 11. The connection switching unit 36 switches the connection mode of the mobile terminal 8 connected to the authentication device 11 in a manner allowing for communication based on the checking result of the terminal checking unit 35. In the present example, if there is only one mobile terminal 8 located near the authentication device 11 (vehicle 1), the connection switching unit 36 sets the communication connection mode of the mobile terminal 8 to “automatic connection,” and if there are multiple mobile terminals 8 located near the authentication device 11 (vehicle 1), the connection switching unit 36 sets the communication connection mode of the mobile terminals 8 to “manual connection.” For example, the terminal checking unit 35 checks the number of mobile terminals 11 located near the authentication device 11 based on the communication area of the authentication device 11 set in and around the passenger compartment of the vehicle 1 that serves as the operation subject 33.

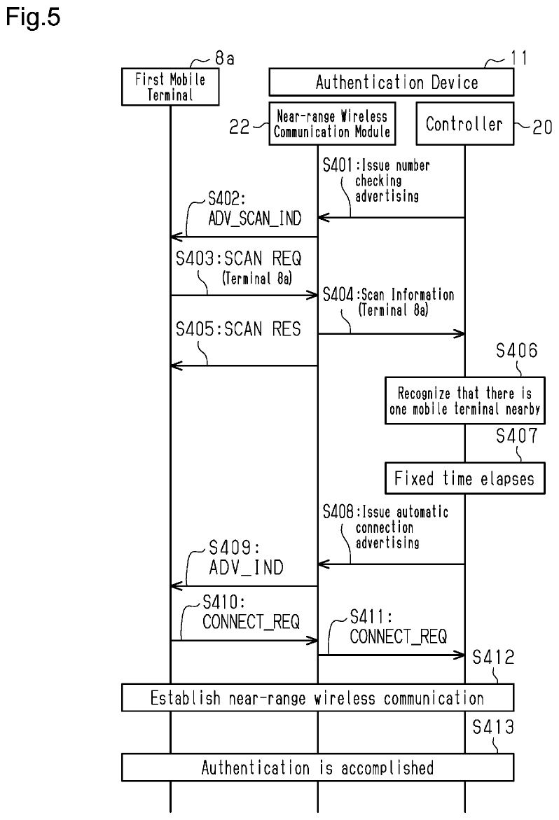

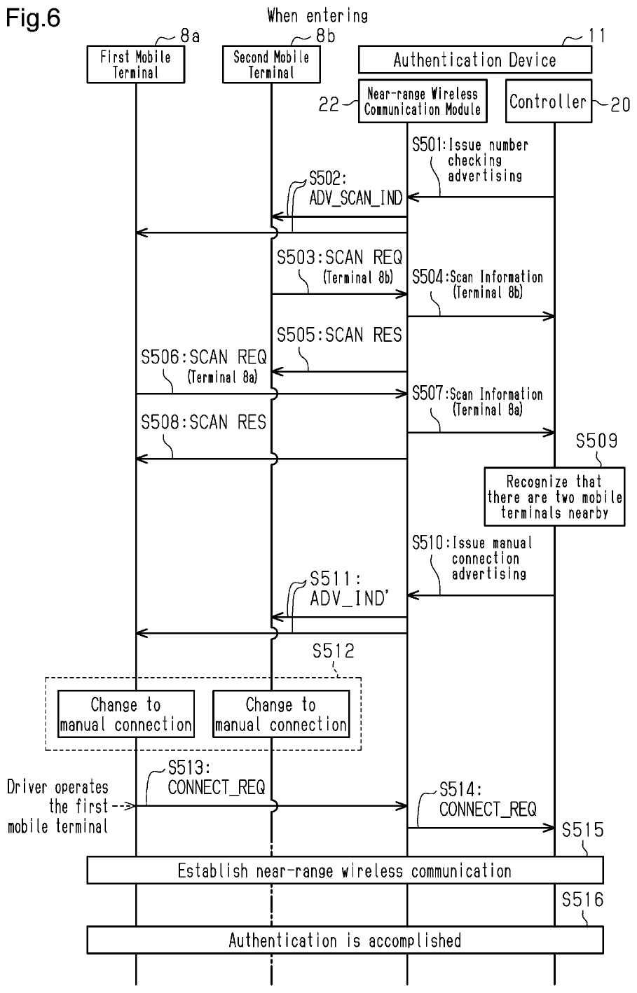

With reference to FIGS. 5 to 6, the operation and advantages of the sharing system 9 in the present embodiment will now be described.

FIG. 5 shows a communication procedure when there is only one connectable mobile terminal 8 (first mobile terminal 8a) located near the vehicle. In step 401, the terminal checking unit 35 of the controller 20, when establishing near-range wireless communication (Bluetooth), outputs a request for issuing an advertising packet that requests the checking of the number of mobile terminals 8 (hereafter referred to as “number checking advertising”) to the near-range wireless communication module 22.

When the request for issuing the number checking advertising is received from the controller 20, in step 402, the near-range wireless communication module 22 transmits an advertising scan indication (ADV_SCAN_IND) for searching for a connectable mobile terminal 8 through near-range wireless communication. In this case, only the first mobile terminal 8a is located near the vehicle 1. Thus, the advertising scan indication reaches only the first mobile terminal 8a.

When the advertising scan indication is received, in step 403, as long as the first mobile terminal 8a is granted privilege to operate the vehicle 1 (code information Dk is assigned), the first mobile terminal 8a transmits a scan request that requests for information other than advertising to the authentication device 11 through near-range wireless communication. In this manner, the first mobile terminal 8a returns only the scan request when the advertising scan indication is received. The first mobile terminal 8a does not return a connect request described later at this time. The scan request sent by the first mobile terminal 8a includes a near-range wireless communication address of the first mobile terminal 8a, that is, a Bluetooth address in the present example.

When the scan request from the first mobile terminal 8a is received, in step 404, the near-range wireless communication module 22 outputs scan information of the first mobile terminal 8a to the controller 20. The scan information is a data group in the scan request. The scan information includes, for example, the Bluetooth address of the first mobile terminal 8a

In step 405, the near-range wireless communication module 22 transmits a scan response to the first mobile terminal 8a through near-range wireless communication. The scan response indicates that the scan request for the first mobile terminal 8a has been received.

In step 406, the terminal checking unit 35 of the controller 20 obtains the Bluetooth address of the first mobile terminal 8a and recognizes that, presently, there is one mobile terminal 8.

In step 407, the terminal checking unit 35 monitors whether scan information (Bluetooth addresses) of another mobile terminals 8 is obtained for a fixed time after obtaining the Bluetooth address of the first mobile terminal 8a. When the fixed time elapses, if one Bluetooth address has been obtained, the terminal checking unit 35 determines that there is one mobile terminal 8 located near the authentication device 11 (vehicle 1). When one mobile terminal 8 is determined to be located near the authentication device 11 (vehicle 1), the connection switching unit 36 recognizes that the connection mode for communication of the first mobile terminal 8a should be set to “automatic connection.”

When setting the connection mode of the first mobile terminal 8a to “automatic connection,” in step 408, the connection switching unit 36 outputs a request for issuing an advertising packet to the near-range wireless communication module 22. The advertising packet (hereafter referred to as “automatic connection advertising”) requests the mobile terminal 8 to switch to automatic connection.

When the request for issuing the automatic connection advertising is received from the controller 20, in step 409, the near-range wireless communication module 22 transmits an advertising indication (ADV_IND: communication connection requesting advertising) that requests the first mobile terminal 8a for communication connection through near-range wireless communication. In this case, “ADV_IND” is an advertising indication that requests the first mobile terminal 8a for automatic connection.

When the advertising indication (ADV_IND) from the authentication device 11 is received, in step 410, the first mobile terminal 8a sets the Bluetooth connection mode to the authentication device 11 to “automatic connection.” Thus, the first mobile terminal 8a tries to establish communication with the authentication device 11 without requiring a separate operation. In this case, the first mobile terminal 8a transmits a connect request as a request for a connection in near-range wireless communication to the authentication device 11 through near-range wireless communication. That is, the first mobile terminal 8a automatically transmits a connect request to the authentication device 11.

When the connect request is received from the first mobile terminal, in step 411, the near-range wireless communication module 22 outputs the connect request to the controller 20.

When the connect request transmitted from the first mobile terminal 8a is obtained, in step 412, the controller 20 (authentication device 11) establishes near-range wireless communication with the first mobile terminal 8a. This connects the first mobile terminal 8a to the authentication device 11 and enables near-range wireless communication.

After establishing near-range wireless communication with the first mobile terminal 8a, in step 413, the authentication device 11 performs authentication with the first mobile terminal 8a. The authentication may be authentication of code information Dk (first code information Dk), authentication of a user authentication code, or the like. If the authentication with the first mobile terminal 8a is accomplished, the authentication device 11 shifts to an authentication completion state and allows the first mobile terminal 8a to operate the vehicle 1. Thus, when the first mobile terminal 8a performs a locking or unlocking operation of the vehicle door, an operation request signal corresponding to the operation is transmitted from the first mobile terminal 8a to the authentication device 11, and locking or unlocking of the vehicle door is performed or permitted.

FIG. 6 shows a communication procedure when there are multiple connectable mobile terminals 8 (first mobile terminal 8a and second mobile terminal 8b) located near the vehicle. The first mobile terminal 8a and the second mobile terminal 8b are set as “partner keys.” Preferably, the partner keys are mobile terminals 8 to which the same group ID (in present example, group ID1) is assigned.

In step 501, the terminal checking unit 35 of the controller 20, when establishing near-range wireless communication (Bluetooth), outputs a request for issuing an advertising packet that requests the checking of the number of mobile terminals 8 (number checking advertising) to the near-range wireless communication module 22.

When the request for issuing the number checking advertising is received from the controller 20, in step 502, the near-range wireless communication module 22 transmits an advertising scan indication (ADV_SCAN_IND) for searching for a connectable mobile terminal 8 through near-range wireless communication. In this case, the first mobile terminal 8a and the second mobile terminal 8b are located near the vehicle 1. Thus, the advertising scan indication reaches both of the first mobile terminal 8a and the second mobile terminal 8b.

When the advertising scan indication is received, in step 503, as long as the second mobile terminal 8b is granted privilege to operate the vehicle 1 (code information Dk is assigned), the second mobile terminal 8b transmits a scan request that requests for information other than advertising to the authentication device 11 through near-range wireless communication. In this manner, the second mobile terminal 8b returns only the scan request in response to the advertising scan indication. At this time, the second mobile terminal 8b does not return a connect request.

When the scan request from the second mobile terminal 8b is received, in step 504, the near-range wireless communication module 22 outputs scan information of the second mobile terminal 8b (Bluetooth address of second mobile terminal 8b) to the controller 20.

In step 505, the near-range wireless communication module 22 transmits a scan response to the second mobile terminal 8b through near-range wireless communication. The scan response indicates that the scan request for the second mobile terminal 8b has been received.

When the advertising scan indication is received, in step 506, as long as the first mobile terminal 8a is granted privilege to operate the vehicle 1 (code information Dk is assigned), the first mobile terminal 8a transmits a scan request that requests for information other than advertising to the authentication device 11 through near-range wireless communication. The scan request sent by the first mobile terminal 8a includes a near-range wireless communication address of the first mobile terminal 8a, that is, a Bluetooth address in the present example.

When the scan request from the first mobile terminal 8a is received, in step 507, the near-range wireless communication module 22 outputs scan information (Bluetooth address of first mobile terminal 8a) of the first mobile terminal 8a to the controller 20.

In step 508, the near-range wireless communication module 22 transmits a scan response to the first mobile terminal 8a through near-range wireless communication. The scan response indicates that the scan request for the first mobile terminal 8a has been received.

In step 509, the terminal checking unit 35 of the controller 20 obtains the Bluetooth address of the first mobile terminal 8a during a fixed time after obtaining the Bluetooth address of the second mobile terminal 8b. Thus, the terminal checking unit 35 determines that there are two (multiple) mobile terminals 8 located near the vehicle 1. When multiple mobile terminals 8 are determined to be located near the vehicle 1, the connection switching unit 36 recognizes that the communication connection of the mobile terminals 8 (first mobile terminal 8a and second mobile terminal 8b) should be set to “manual connection.”

When multiple mobile terminals 8 are determined to be located near the vehicle 1, in step 510, the connection switching unit 36 outputs a request for issuing an advertising packet (request for issuing manual connection advertising) to the near-range wireless communication module 22. The advertising packet (hereafter referred to as “manual connection advertising”) requests the mobile terminals 8 to switch to manual connection.

When the request for issuing the manual connection advertising is received from the controller 20, in step 511, the near-range wireless communication module 22 transmits an advertising indication (ADV_IND': manual connection requesting advertising) for requesting a change to manual connection through near-range wireless communication. In this case, the first mobile terminal 8a and the second mobile terminal 8b are located near the vehicle 1. Thus, the advertising indication (ADV_IND′) reaches both of the first mobile terminal 8a and the second mobile terminal 8b.

In step 512, the first mobile terminal 8a and the second mobile terminal 8b receive the advertising indication (ADV_IND′) from the authentication device 11 and changes the connection mode for near-range wireless communication from automatic connection to manual connection. Thus, the first mobile terminal 8a and the second mobile terminal 8b are required to separately undergo a communication connection operation performed on the terminal to communicate with the authentication device 11. Preferably, the communication connection operation is tapping of a connection button displayed on the screen of the first mobile terminal 8a or the second mobile terminal 8b.

When the communication connection operation is performed on the first mobile terminal 8a in the manual connection state, in step 513, the first mobile terminal 8a transmits a connect request that requests for connection in near-range wireless communication to the authentication device 11 through near-range wireless communication.

When the connect request is received from the first mobile terminal, in step 514, the near-range wireless communication module 22 outputs the connect request to the controller 20.

When the connect request transmitted from the first mobile terminal 8a is obtained, in step 515, the controller 20 (authentication device 11) establishes near-range wireless communication with the first mobile terminal 8a (same as step 412). This allows the first mobile terminal 8a to be connected to the authentication device 11 and perform near-range wireless communication.

After establishing near-range wireless communication with the first mobile terminal 8a, in step 516, the authentication device 11 performs authentication with the first mobile terminal 8a (same as step 413). If the authentication between the authentication device 11 and the first mobile terminal 8a is accomplished, the authentication device 11 shifts to an authentication completion state and allows the first mobile terminal 8a to operate the vehicle 1.

In the present example, even if multiple mobile terminals 8 have been granted privilege to operate the vehicle 1 (code information Dk is assigned) in advance, the connection mode of the mobile terminals 8 is set based on the number of mobile terminals 8 that are actually located near the vehicle 1 at the moment. Thus, the connection mode of the mobile terminals 8 will be appropriately set in accordance with the number of mobile terminals 8 that are actually located near the vehicle 1 at the moment rather than the number of privileges granted to operate the vehicle 1 (code information Dk). This optimally sets the connection mode of the mobile terminals 8.

The connection switching unit 36 switches the connection mode to automatic connection or manual connection depending on the number of mobile terminals 8 connectable to the authentication device 11. Thus, when there are multiple mobile terminals 8 located near the vehicle, the connection mode will be set to manual connection, and when there is only one mobile terminal 8 located near the vehicle, the connection mode will be set to automatic connection. Accordingly, even if multiple mobile terminals 8 have been granted privilege to operate the vehicle 1, when there is only one mobile terminal 8 located near the vehicle, the connection mode of the mobile terminal 8 will be set to automatic connection. This improves usability when connecting the mobile terminal 8 to the authentication device 11 in a manner allowing for communication.

If the mobile terminal 8 is granted privilege to operate the vehicle 1, the mobile terminal 8 returns a response (scan response) in response to a call (advertising scan indication) transmitted from the authentication device 11. The terminal checking unit 35 monitors the response (challenge response) and checks how many mobile terminals 8 are located near the authentication device 11. If a call is transmitted from the authentication device 11, only the mobile terminals 8 that are granted privilege to operate the vehicle 1 can return a response and the other terminals that are not granted privilege or are irrelevant cannot return a response.

The terminal checking unit 35 checks whether two or more mobile terminals 8 are located near the authentication device 11 by monitoring for a fixed time whether responses (challenge response) from two or more mobile terminals 8 are received in response to a call (advertising scan indication) transmitted from the authentication device 11. Thus, the simple process of monitoring a response from the mobile terminals 8 for a fixed time allows for recognition of the number of the mobile terminals 8 that are located nearby.

The present embodiment may be modified as follows. The present embodiment and the following modifications can be combined as long as the combined modifications are not in contradiction.

The advertising scan indication transmitted from the authentication device 11 may include, for example, information that actuates only a mobile terminal 8 of which code information Dk is registered in the authentication device 11. Only the mobile terminal 8 of which the code information Dk has been registered in the authentication device 11 may respond to the advertising from the authentication device 11. In this case, communication with only the relevant mobile terminal 8 starts in response to the advertising of the authentication device 11.

A scan request does not need to be returned by only mobile terminals 8 that are granted privilege to operate. Terminals that are not granted privilege to operate may also transmit a scan request.

The number of mobile terminals 8 does not have to be checked when communication connection starts. For example, when communication with one of the mobile terminals 8 is established, a process of searching for another mobile terminal 8 can be started.

The number of mobile terminals 8 does not need to be checked through the transmission and reception of an advertising scan indication and a scan response. Instead, the number may be checked using other types of radio waves.

Connections are not limited to “automatic connection” and “manual connection.” Connections may be changed to other connection forms.

A scan request does not need to be transmitted by a mobile terminal 8 that is granted operation privilege and may be transmitted from a terminal that does not have operation privilege.

A call does not need to be an advertising scan indication. Instead, the call may be any signal to search for the mobile terminal 8.

A response does not need to be a scan request. Instead, the response may be any signal transmitted in reply to a call.

The second mobile terminal 8b may be a terminal set as a valet key.

The authentication device 11 may be retrofitted to the vehicle 1 or installed in the vehicle 1 in advance.

The authentication device 11 may be installed anywhere in the vehicle 1.

The operation of the mobile terminal 8 to actuate the vehicle 1 may be modified in various manners.

The reservation procedure for the vehicle 1 does not need to be performed by the mobile terminal 8. Instead, the reservation procedure may be performed by a different terminal.

Code information Dk does not need to be a one-time key. Instead, the code information Dk may be information including a data element for imposing limitations on time to use the code information Dk.

The content included in the code information Dk may be changed to forms other than that of the above embodiment.

The code information Dk does not need to be generated in the data center 10. Instead, the code information Dk may be generated in any external location.

The mobile terminal 8 does not need to be a high-performance mobile phone and may be replaced by any of various types of terminals.

The mobile terminal 8 and the authentication device 11 may obtain a user authentication code through any procedure or method.

The key function unit 28 may be switched to an ON state (enabled) under any condition.

Operation privilege may be granted to another user by, for example, having the terminal of the other user (second mobile terminal 8b) directly send an inquiry to the data center 10 and obtaining the operation privilege (code information Dk).

Near-range wireless communication does not need to be Bluetooth communication and may be changed to other communication protocols.

The communication between the mobile terminal 8 and the authentication device 11, the communication between the system device 5 and the authentication device 11, the communication between the electronic key 2 and the system device 5, and the communication between the mobile terminal 8 and the data center 10 may use various types of frequencies and communication protocols.

The electronic key system 4 does not need to be a key-operation-free system but may be replaced by other system structures.

The encryption code used in encrypted communication may be any one of code information Dk, unique authentication device encryption code, user authentication code, and unique electronic key encryption code. The switching of encryption codes used during a process improves the security of communication. Encryption codes that are used do not need to be the above codes and may be replaced by various types of codes.

The communication between the authentication device 11 and the controller 20 may be wired or wireless.

The system device 5 and the authentication device 11 do not need to be wireless-connected and may be wire-connected.

The authentication device 11 may output a command corresponding to a request received from the mobile terminal 8 to the system device 5 (wireless or wired communication) so that the vehicle 1 operates in response to the request obtained from the mobile terminal 8.

The operation subject 33 is not limited to the vehicle 1 and may be changed to other subjects, for example, a room of a lodging facility (in this case, mobile terminal 8 may be used to lock and unlock a room door or the like), a gate for a coin-operated parking lot, a shared delivery locker, or the like.

Facilities in which the operation subject 33 is disposed may be changed to various types of subjects such as private lodging facilities.

1. A sharing system, comprising:
an authentication device arranged in an operation subject;
mobile terminals that obtain code information required to use the operation subject, wherein the mobile terminals are allowed by the authentication device to operate the operation subject if authenticated through communication with the authentication device;
a terminal checking unit that checks how many of the mobile terminals located near the authentication device can connect to the authentication device in a manner allowing for communication and can operate the operation subject; and
a connection switching unit that switches a connection mode of the mobile terminals that are connected to the authentication device in a manner allowing for communication based on a checking result of the terminal checking unit.

2. The sharing system according to claim 1, wherein the connection switching unit switches the connection mode to automatic connection or manual connection in accordance with how many of the mobile terminals are connectable to the authentication device.

3. The sharing system according to claim 1, wherein
when the mobile terminals are granted privilege to operate the operation subject, the mobile terminals each return a response to a call transmitted from the authentication device, and
the terminal checking unit checks how many of the mobile terminals are located near the authentication device by monitoring the response.

4. The sharing system according to claim 1, wherein the terminal checking unit checks whether two or more of the mobile terminals are located near the authentication device by monitoring over a fixed time whether responses from two or more of the mobile terminals are received in response to a call transmitted from the authentication device.

5. A method for switching a connection mode of a sharing system, wherein the sharing system includes an authentication device arranged in an operation subject and mobile terminals that obtain code information required to use the operation subject, wherein the mobile terminals are allowed by the authentication device to operate the operation subject if authenticated through communication with the authentication device, the method comprising:
checking how many of the mobile terminals located near the authentication device can connect to the authentication device in a manner allowing for communication and can operate the operation subject; and
switching a connection mode of the mobile terminals that are connected to the authentication device in a manner allowing for communication based on a checking result of how many of the mobile terminals are connected.
